(19) United States
(12) Patent Application Publication
(10) Pub. No.: US 2004/0261277 A1
(43) Pub. Date: Dec. 30, 2004

(54) Estimating apparatus

(76) Inventor: Brett Raymond Hughes, Mermaid Waters (AU)

Correspondence Address: HOFFMAN WASSON & GITLER, P.C, CRYSTAL CENTER 2, SUITE 522, 2461 SOUTH CLARK STREET, ARLINGTON, VA, 22202-3843, US

(21) Appl. No.: 10/491,440

(22) PCT Filed: Oct. 16, 2002
(86) PCT No.: PCT/AU02/01404

(30) Foreign Application Priority Data
Nov. 9, 2001 (AU) PR8769
Sep. 5, 2002 (AU) 2002300874

(51) Int. Cl. G01D 21/00

(52) U.S. Cl. 33/1 SB

(57) ABSTRACT

A template for estimating quantities of building materials for specific construction provides indicia for relating measurements to construction details to arrive at quantitative measurements.

### TECHNICAL FIELD

The present invention relates to estimating templates and has particular relevance to templates which allow a user to estimate the quantities of materials required for specific budding and construction projects

### BACKGROUND ART

Over estimating the quantities of materials required for building and construction projects is wasteful especially as it is rare for suppliers to accept returned goods and to offer refunds.

Professional builders and handyman often overestimate material quantities, even with respect to relatively simple tasks such as building fences, retaining walls, pergolas and the like.

A number of proposals to assist estimation procedures have been made in the past including the following:

French patent no. 2,246,004 which discloses a slide rule for estimating the required thickness of insulation for a particular heat transfer co-efficient;

German patent no. DE 100 38 886 which discloses a method for entering dimensions of an area to be laid with tiles into a computer which then determines the number of tiles required; and

European patent no. EP 1 128 291 which discloses a system for preparing 3D drawings of proposed structures and calculating the quantity of construction materials required to produce the structure.

It is an object of the present invention to provide a simple and affective estimating template which will enable professional builders, contractors, students, trainees and do-it-yourself (D.I.Y) persons to accurately estimate the quantities of materials required for a large range of specific building and construction works.

Further objects and advantages of the present invention will become apparent from the ensuing description which is given by way of example only.

### DISCLOSURE OF INVENTION

According to the present invention, there is provided an estimating template comprising a substantially rectilinear body sheet, first indicia on the template which extends across the body sheet, second indicia which extends down one or both sides of the body sheet and third indicia which is centrally positioned on the body sheet adjacent to the first and second indicia, characterised in that the first indicia provides distance measurements, the second indicia specifies construction details and the third indicia provides quantitative data.

The first indicia can be to scale e.g. 1:100.

The body sheet can be transparent.

The distance measurements can be metric or imperial

The template can be adapted to estimate quantities for common building elements such as studs, joists, rafters, battens, sheet materials such as cladding, flooring and roofing, and volumetric quantities for materials such as concrete.

The first indicia can comprise two rows of distance measurements, a first adjacent a top edge of the template and a second towards the centre of the template.

### BRIEF DESCRIPTION OF DRAWINGS

Aspects of the present Invention will now be described with reference to the accompanying drawings in which

FIG. 1 is a plan view of a template according to one possible embodiment of the present invention, and

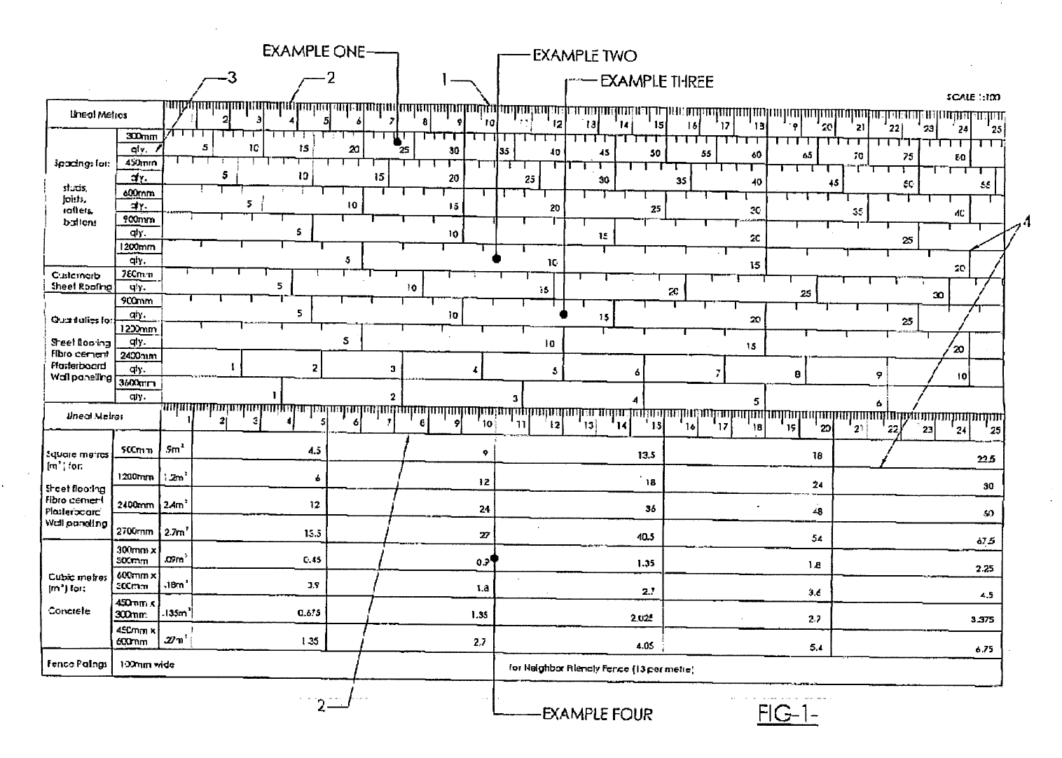

FIG. 2 is a plan of a shed showing the floor layout and elevation.

With respect to the drawing a template according to the present invention comprises a rectilinear body sheet generally indicated by arrow 1, first indicia generally indicated by arrow 2 which extends across the body sheet, second indicia generally indicated by arrow 3 which extends down at least one side of the body sheet and third indicia generally indicated by arrow 4 which is centrally positioned on the body sheet adjacent to the first and second indicia.

The first indicia 2 provides distance measurements.

The second indicia 3 specifies construction details.

The third indicia 4 provides quantitative data.

The second indicia can be based on common spacings for studs, joists, rafters, battens and the like, sheet sizes for cladding, flooring and roofing materials, and volumetric sizes.

Examples of use of the template and resulting quantitative measurements indicated on the drawing are as follows;

### EXAMPLE ONE

To quantify materials required for a seven metre length of wall framing with studs at 300 mm centres, the linear measurement of seven metres (indicia 2) is identified. Indica 4 below indicates that 25 studs at the desired length of stud timber material is required.

### EXAMPLE TWO

Estimation of the number of rafters required to cover a ten metre span at 1200 mm centres involves selecting the linear measurement of ten metres, selecting the 1200 mm spacing. The plot position identified on the drawing indicates that ten rafters are required.

### EXAMPLE THREE

To estimate the number of flooring sheets of say 3600 mm ×900 mm required to cover a floor of 14 metres long×900 mm wide sheets a plot taken on the lineal measurement scale down to the 900 mm box of the second indicia indicates 4 sheets will be required.

### EXAMPLE FOUR

To estimate the quantity of concrete required to complete a 10 metre long footing 300×300 mm a lineal measurement of 10 metres is plotted downwardly where as with the 300×300 mm box of the second indicia indicating a quantity of concrete of 9 m of concrete is required.

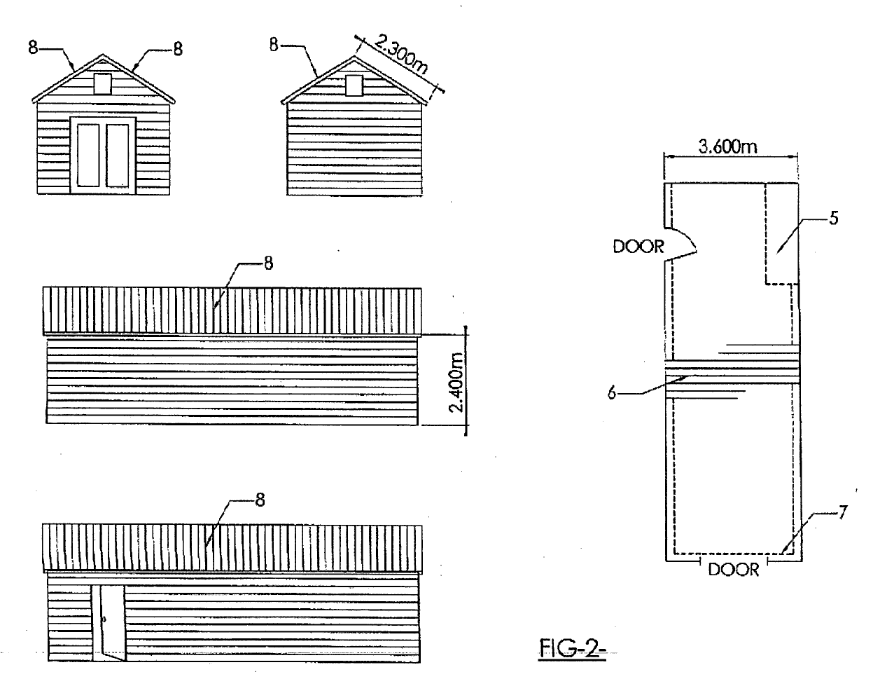

With respect to FIG. 2 of the drawings which shows plan and elevations of a shed, the quantities of materials required can be assessed by measurement (where dimensions on the plan may not be given) and by using the template to determine quantities.

In this particular instance, the following estimations can be made;

| | |
|---|---|
| Sheet Flooring 5: | Coverage of 3.6 m × 10.5 m of 3600 mm × 900 mm |
| | sheets would require 12 sheets. |
| Floor Joists 6: | Because the floor joists are spaced at 450 centres, |
| | the quantity required is 25 joists @ 3.6 m long. |
| Concrete | Each side requires a 600 mm deep by 300 mm wide |
| Footings 7: | footing indicating 1.89 m³ of concrete is required. |
| Roofing 8: | Each side requires 14 sheets of 2.3 m long. |
| Wall Studs 9: | Each side wall requires studs at 600 m centres, the |
| | quantity being 19 at 2400 mm lengths. |

In each case, the first indicia on the template confirms or establishes distance measurements, the second indicia materials and the third indicia quantities.

It is considered that present invention will be a handy tool for both trades people, students, trainees and DIY persons for accurately measuring quantities.

By providing information on commonly specified construction details the template will assist with most tasks without the need for calculation and avoiding the consequences of miscalculation.

Where the template is transparent and to scale it can be placed on plans to further enhance the accuracy of measurements to further reduce the likelihood of error.

Aspects of the present invention have been described by way of example only and it will be appreciated that modifications and additions thereto may be made without departing from the scope thereof as defined in the appended claims.

1. An estimating template comprising a substantially rectilinear body sheet, first indicia on the template which extends across the body sheet, second indicia which extends at least partially down one or both sides of the body sheet, third indicia which extends at least partially down one or both sides of the body sheet adjacent the second indicia, fourth indicia which is positioned on the body sheet adjacent to the first and second indicia and fifth indicia which is positioned on the body sheet adjacent to the fourth and third indicia, characterised in that the first indicia provides distance measurements, the second indicia specifies construction details regarding linear properties of material used, the third indicia specifies construction details regarding volumetric properties of material used the fourth indicia provides quantitative data regarding linear properties of material required and the fifth indicia provides quantitative data regarding volumetric properties of material required.

2. A template as claimed in claim 1 wherein the first indicia is to scale e.g. 1:100.

3. A template as claimed in claim 1 wherein the body sheet is transparent.

4. A template as claimed in claim 1 wherein the distance measurements are metric or imperial.

5. A template as claimed in claim 1 adapted to estimate quantities for common building elements such as studs, joists, rafters, battens, sheet materials such as cladding, flooring and roofing, and volumetric quantities for materials such as concrete.

6. A template as claimed in claim 1 wherein the first indicia includes two rows of distance measurements, a first adjacent a top edge of the template and a second towards the centre of the template.

7. (Cancelled)
